(19) United States
(12) Patent Application Publication
(10) Pub. No.: US 2012/0111707 A1
(43) Pub. Date: May 10, 2012

(54) Stressing Apparatus

(75) Inventors: Karsten Freundt, Falkensee (DE); Klaus Klimek, Neresheim (DE); Karl-Heinz Voss, Dallgow-Doberitz (DE)

(73) Assignee: SIEMENS AKTIENGESELLSCHAFT, Munchen (DE)

(21) Appl. No.: 12/063,446

(22) PCT Filed: Aug. 10, 2005
(86) PCT No.: PCT/DE05/01437

§ 371 Date: Feb. 11, 2008

(51) Int. Cl. H01H 5/04

(52) U.S. Cl. 200/468

(57) ABSTRACT

In order to form a tensioning apparatus for a switch-on energy store of a circuit breaker, in which apparatus a tensioning shaft, which can rotate by means of a drive wheel, for tensioning the switch-on energy store is fixedly connected in each case to a cam and to a cam disc, which apparatus has a tripping stop, in which apparatus the drive wheel is coupled to the tensioning shaft via a clutch, and which apparatus has a simple and at the same time cost-effective design, the invention proposes that the clutch is a ratchet arrangement.

The invention relates to a stressing apparatus for a switch-on energy store for a circuit breaker, in which a stressing shaft, which can be rotated by means of a drive wheel, is in each case firmly connected to an eccentric and to a cam disk in order to stress the switch-on energy store, which has a tripping stop, and in which the drive wheel is coupled to the stressing shaft via a coupling.

A stressing apparatus such as this is known from DE 199 33 637 C1. In this stressing apparatus, a spur gear as a drive wheel is disconnected by a disconnectable coupling after stressing of a switch-on spring as a switch-on energy store. The disconnection or disengagement means that the spur gear, which is the spur gear of a transmission, and therefore the transmission can continue to run or rotate without any increased wear to the stressing apparatus or to the transmission, for example as a result of irregular operation. The disconnectable coupling in this case comprises a bearing sleeve which can be moved via balls and engages via a toothed surface with a toothed surface on the spur gear as long as a lever system, comprising two levers which are mounted such that they can rotate and have wedge-shaped surfaces, and a toggle-lever system, which is connected thereto, couples the bearing sleeve to the spur gear via a pressure element. Once the stressing process has been carried out, the toggle-lever system is erased via a further pressure element, as a result of which the two levers are rotated such that the spur gear is disengaged from the bearing sleeve. The arrangement having a bearing sleeve, which can be moved via a ball bearing and is coupled to and disengaged from the spur gear of the transmission via a lever system comprising a plurality of levers, which are mounted such that they can rotate, and toothed surfaces, represents a complex arrangement, which is costly at the same time.

The object of the present invention is to design a stressing apparatus of the type mentioned initially which has a simple and low-cost design.

The object is achieved in that, according to the invention, the coupling is a latching arrangement. A latching arrangement such as this creates a stressing apparatus whose coupling is advantageously simple and at the same time costs little, because the low-latching arrangement requires only a comparatively small number of components. In this case, it is only the latching arrangement which prevents irregular loading of the stressing apparatus taking place by further operation of the drive wheel after a stressing process, for example while a motor drive is running down.

In one preferred embodiment, the latching arrangement has a catch which is arranged on the drive wheel such that it can rotate, and a fixed stop element is provided in order to control the catch. An arrangement such as this has the advantage that the catch can be controlled, and the drive wheel can therefore disengage from the stressing shaft, solely by the arrangement of the catch such that it can rotate, and the fixed stop element.

In one advantageous refinement, the fixed stop element is arranged such that the catch releases the stressing shaft when the switch-on energy store is stressed. An arrangement such as this offers a simple capability to disengage the stressing shaft from the drive after a stressing process once the switch-on energy store has been stressed.

In another advantageous refinement, the latching arrangement has a driver which is firmly connected to the stressing shaft and interacts with the catch. The arrangement of a driver such as this is a simple and expedient option for coupling the drive wheel and the stressing shaft to one another by means of the catch, in order to carry out a stressing process.

The free end of the latching arrangement may be guided in various ways, for example by means of a fixed-position guide path. In one advantageous development, the latching arrangement has a spring element. The provision of a spring element ensures that the catch is held in a position in which it interacts with the driver during a stressing process.

In a further preferred refinement of the invention, a position pin is provided on the drive wheel. The provision of a position pin such as this advantageously limits the rotation of the catch, which is mounted such that it can rotate, by the force which is transmitted from the spring element, thus preventing wear to the catch resulting from a sliding movement on the stressing shaft during rotation for preparation for a stressing process of the circuit breaker.

The invention will be explained in more detail in the following text using the attached drawings and one exemplary embodiment, and with reference to the figures, in which:

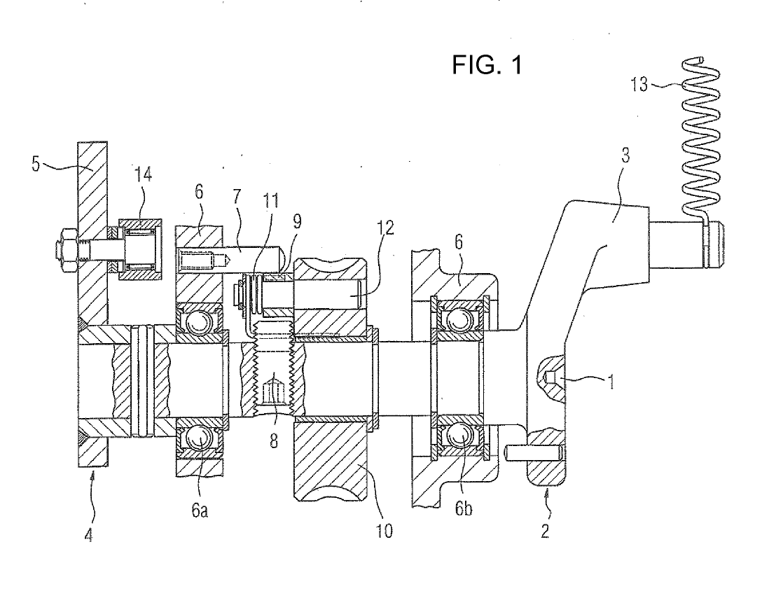

FIG. 1 shows a schematic side view of the stressing apparatus according to the invention;

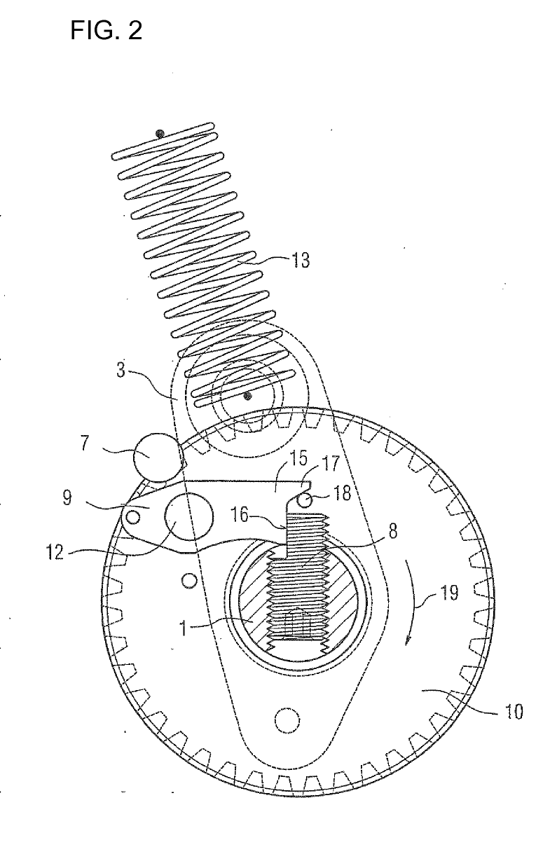

FIG. 2 shows a front view of the stressing apparatus from FIG. 1, in a first position during the stressing process; and

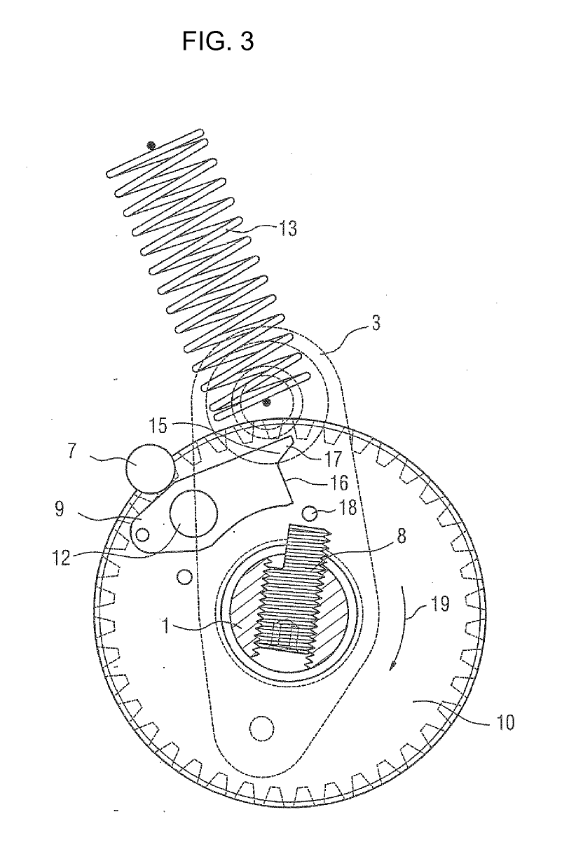

FIG. 3 shows a front view of the stressing apparatus in a disengaged position.

FIG. 1 shows a stressing apparatus according to the invention for a switch-on energy store, in the form of a schematic side view. The apparatus has a stressing shaft 1 at whose first end 2 an eccentric 3 is arranged. A cam disk 5 is firmly connected to the stressing shaft 1, at the second end 4 of the stressing shaft 1. In a circuit breaker, the cam disk 5 is operatively connected to a switching shaft, which is not illustrated, in order to transmit the energy stored in the switch-on energy store, in order to close moving contacts of the circuit breaker. A fixed stop element 7 is arranged on a housing part 6 of the stressing apparatus, in which housing part 6 the stressing shaft 1 is mounted by means of ball bearings 6a, 6b such that it can rotate. The stressing shaft 1 is firmly connected to a driver 8 which interacts via a catch 9 with a drive wheel 10. In this case, the catch 9 is arranged such that it can rotate on the drive wheel 10, by means of a spring element 11. The drive wheel 10 is the last drive wheel of the transmission which is not illustrated, for example of a worm gear, which can be driven by means of the hand-crank or motor drive. A switch-on energy store 13, for example a spring element 13, is arranged articulated on the eccentric 3. A tripping stop 14 is provided as a stop for the stressing apparatus after a stressing process, in which case the tripping stop can be tripped by means of a tripping mechanism which is not illustrated, in order to carry out a switching process for the circuit breaker when the switch-on energy store is stressed.

FIG. 2 shows a front view of the stressing apparatus according to the invention in a position during the process of stressing the switch-on energy store. At its end 15, the catch 9 makes contact with the driver 8 via the contact surface 16. A stop 17 is formed at the end 15 of the catch 9, and rests on a position pin 18 on the drive wheel 10. The stressing shaft 1 and therefore the eccentric 3 are caused to rotate in the clockwise direction via the catch 9, which rests on the driver 8, by using the drive to rotate the drive wheel 10. This results in stressing of the switch-on energy store 13 which is mounted on the eccentric. In the position shown in FIG. 2, the eccentric 3 is located at a position in which the switch-on energy store 1 is subject to its maximum compression-spring stress. In order to produce a torque which is required to initiate a switching process, the eccentric must be rotated further to a position which is a few degrees away from this maximum extended position.

FIG. 3 shows the position of the catch 9 after the process of stressing the switch-on energy store 13 has been completed. As the drive wheel 10 rotates in the clockwise direction, the catch 9 makes contact with the fixed stop element 7, thus causing the catch 9 to rotate about the shaft 12 in the counterclockwise direction, so that the contact surface 16 no longer rests on the driver 8, and the catch is pivoted away from the driver 8. The stressing shaft 1 is disengaged from the drive wheel 10, and therefore from the drive, in this position. In consequence, no more force is exerted on the cam disk or on the eccentric when the drive wheel 10 is rotated further.

During a switching-on process, the tripping stop 14 is released, so that the energy stored in the switch-on energy store 13 is used to rotate the cam disk 5, which is connected to the stressing shaft 1, and therefore to close the moving contact of the circuit breaker. During the process, the stressing shaft 1 rotates, and the parts which are connected to it rotate in the direction of the arrow 19 in FIG. 3, until the switch-on energy store 13 has been completely unloaded. The drive wheel 10 with the catch 9 remains in the position shown in FIG. 3 during this process. In consequence, no energy is transferred to the drive wheel and to the drive during the switching process. When a new stressing process is carried out after the switching process, then the drive wheel 10 is likewise moved in the direction of the arrow 19, via the drive. During the process, the catch is deflected further on the fixed stop element 7 and moves along it until the rotation of the drive wheel results in the catch no longer making contact with the fixed stop element, and being rotated in the direction of the stressing shaft by the force exerted by the spring element 11, until the catch rests on the position pin 18. The position pin 13 prevents the catch 9 from resting on the stressing shaft 1 while the drive wheel 10 is rotated further. Further rotation results in the catch 9 making contact with the driver 8, so that the drive wheel 10 and the stressing shaft 1 are coupled again, and the switch-on energy store 13 is stressed again.

### LIST OF REFERENCE SYMBOLS

1 Stressing shaft

2 First end

3 Eccentric

4 Second end

5 Cam disk

6 Housing part

6a, 6b Ball bearing

7 Fixed stop element

8 Driver

9 Catch

10 Drive wheel

11 Spring element

12 Shaft

13 Switch-on energy store

14 Tripping stop

15 End of catch

16 Contact surface

17 Stop

18 Position pin

19 Arrow

1-6. (canceled)

7. A stressing apparatus for a switch-on energy storage apparatus of a circuit breaker, comprising:
a rotatably mounted stressing shaft for tensioning the switch-on energy storage apparatus;
a drive wheel for rotating said stressing shaft;
an eccentric and a cam disk each rigidly connected to said stressing shaft;
said cam disk carrying a tripping stop; and
a latching configuration coupling said drive wheel to said stressing shaft.

8. The stressing apparatus according to claim 7, wherein:
said latching configuration includes a catch rotatably mounted on said drive wheel; and
a fixed stop element is disposed to control said catch.

9. The stressing apparatus according to claim 8, wherein said fixed stop element is disposed to cause said catch the release said stressing shaft when the switch-on energy storage apparatus is stressed.

10. The stressing apparatus according to claim 8, wherein said latching configuration includes a driver firmly connected to said stressing shaft and disposed to interact with said catch.

11. The stressing apparatus according to claim 7, wherein said latching configuration includes a spring element.

12. The stressing apparatus according to claim 11, which comprises a position pin disposed on said drive wheel.
